(19) United States
(12) Patent Application Publication
(10) Pub. No.: US 2021/0361523 A1
(43) Pub. Date: Nov. 25, 2021

(54) MASSAGE CHAIR HAVING IMPROVED STRETCHING FUNCTIONALITY

(71) Applicant: KAMSAHAN CO.,LTD., Gimhae-Si (KR)

(72) Inventor: Tae Yeon PARK, Seoul (KR)

(73) Assignee: KAMSAHAN CO.,LTD., Gimhae-Si (KR)

(21) Appl. No.: 16/651,235

(22) PCT Filed: Nov. 12, 2018
(86) PCT No.: PCT/KR2018/013746

§ 371 Date: Mar. 26, 2020

(30) Foreign Application Priority Data
Nov. 15, 2017 (KR) 10-2017-0152551
May 31, 2018 (KR) 10-2018-0062252
Sep. 20, 2018 (KR) 10-2018-0112665

(51) Int. Cl. A61H 15/00; A61H 9/00; A61H 1/02; A61H 23/02

(52) U.S. Cl. CPC A61H 15/0078; A61H 2203/0431; A61H 9/005; A61H 1/0237; A61H 1/0292; A61H 23/0254; A61H 2015/0014; A61H 2201/0149; A61H 2201/025; A61H 2201/1215; A61H 2201/1238; A61H 2201/1623; A61H 2201/164; A61H 2201/1614; A61H 9/0021

(57) ABSTRACT

Disclosed is a massage chair with improved stretching performance. The massage chair includes a seating unit (20); a backrest unit (10) with a pair of massage rollers (40) installed to left and right sides thereof; a footrest unit (30) or an ankle holder (33) provided to a front lower portion of the backrest unit (10) to hold both feet; and an upper body stretching unit (50) installed to a rear portion of the backrest unit (10) to lift a hand lever (51) by a driving force, in which when the hand lever (51) is lifted in a state in which a user holds the hand lever (51) by both hands, the whole body is stretched. The lower portion of the backrest unit (10) is optionally provided with a lumbar stretching unit (70) for stretching a waist of the user, and an air conditioner (460) for supplying air to the backrest unit (10), so that the user can get over feeling tired.

### TECHNICAL FIELD

The present invention relates to a massage chair with improved stretching performance, and more particularly, to a massage chair having a function of massaging a back and shoulder of a user that can provide a stretching effect to upper and lower bodies and lumbar vertebrae of the user sitting on the chair.

### BACKGROUND ART

Various types of robotic massage chairs are commercially available that can repeatedly provide various functions, such as a rubbing function, a vibrating function and a pressurizing function, to a back and limbs of a user's body by massage rollers built in the massage chair according to a desired time setting program.

One example of the robotic massage chairs is disclosed in Korean Patent Publication No. 10-0625850, entitled ‘Whole body massage chair’. The massage chair of the related art is configured to allow a user to receive massage by inclining an angle according to a body type of the user sitting on the chair. The massage chair of the related art includes a backrest, a seating plate for massaging thighs and hips, and an adjustable leg massage device so as to provide the user with various massage in a comfort posture. In particular, the massage chair of the related art is configured to comfortably massage the whole body of the user at portions corresponding to the backrest, the seating plate and a footrest simultaneously or individually. The backrest is provided with a back massaging unit which can be operated in various ways. The massage chair of the related art can massage the legs, and the height thereof can be easily adjusted to provide comfort massage.

The massage chair of the related art has a problem in that the massage rollers provide the user with the massage using the vibrating and pressurizing functions, but cannot provide a stretching effect to rest from user's fatigue, so that the user does not feel much refreshed.

### PRIOR ART DOCUMENTS

### Patent Literatures

Patent Document 1: Korean Patent Publication No. 10-0625850 (Sep. 12, 2006)

Patent Document 2: Korean Utility Model No. 20-0304546 (Feb. 4, 2003)

### DISCLOSURE

### Technical Problem

Accordingly, in addition to the simple massage functions provided by the massage rollers of the massage chair according to the related art, one object of the invention is to provide a massage chair with improved stretching performance that can provide various massage effects including a stretching function to relieve muscles and ligaments of a user's body.

Another object of the invention is to provide a massage chair including a lumbar stretching unit at a waist region of a user which is moved up and down by an actuator using a cylinder or an electric motor, thereby pressurizing or relieving lumbar vertebrae.

The other object of the invention is to provide a massage chair with improved stretching performance, of which a backrest unit is fed with sufficient quantities of air to eject it toward a user's body, so that the user can receive more comfortable massage.

### Technical Solution

To accomplish the above-mentioned objects, according to one aspect of the invention, there is provided a massage chair with improved stretching performance comprising: a seating unit 20; a backrest unit 10 with a pair of massage rollers 40 installed to left and right sides thereof; a footrest unit 30 or an ankle holder 33 provided to a front lower portion of the backrest unit 10 to hold both feet; an upper body stretching unit 50 installed to a rear portion of the backrest unit 10 to lift a hand lever 51 by a driving force; and a lumbar stretching unit 70 installed to a lower portion of the backrest unit 10, and having a lumbar supporter 72 connected to an actuator 79 and moved up and down by the actuator.

The footrest unit 30 is provided with an air tube which is contracted or expanded by pneumatic pressure to massage the user. The massage chair 1 is provided therein with a footrest transfer motor 64 to move the footrest unit 30 forward or rearward, so that when the hand lever 51 is lifted, the footrest unit 30 is moved forward to pull a lower body of the user, thereby simultaneously stretching upper and lower bodies.

The backrest unit 10 includes at a lower portion thereof a lumbar stretching unit 70 having an actuator 79 and a lumbar supporter 72 connected to the actuator 79 and moved up and down by the actuator, so that when the lumbar supporter 72 moves forward, lumbar vertebrae of the user are pressurized.

According to another aspect of the invention, there is provided a massage chair with improved stretching performance including: a seating unit 20; a backrest unit 10 with a pair of massage rollers 40 installed to left and right sides thereof; support frames 11 provided to support the massage chair 1 from both inner sides of the backrest unit 10 and the seating unit 20; and an air conditioner 460 provided in the backrest unit 10 to supply air to an operation space 10a which is formed between the support frames 11, in which the massage rollers 40 are operated.

### Advantageous Effects

With the above configuration of the invention, the upper portion of the robotic massage chair is provided with the hand lever of a horizontal bar type which can be easily held by hands, and the hand lever is configured to be lifted to stretch the upper body of the user. Simultaneously, the footrest unit is moved forward, so that the user can effectively relief muscles and ligaments of the whole body, and get over feeling tired

While the upper and lower bodies are stretching, the lumbar vertebrae of the user are pressurized and relaxed by operation of the lumbar stretching unit installed adjacent to the waist, so that the user can feel relaxation of the waist, and backache can be relieved.

The backrest unit is provided with the air conditioner to supply the air to the operation area of the massage rollers, so that the user can receive the massage under more comfortable circumstances.

### DESCRIPTION OF DRAWINGS

FIG. 1 is a perspective view illustrating a massage chair with improved massage performance according to one embodiment of the invention, of which a backrest unit is cut;

FIG. 2 is an exploded perspective view illustrating the detailed configuration of an upper body stretching unit of the massage chair according to one embodiment of the invention;

FIG. 3 is a view illustrating a configuration of connecting the upper body stretching unit and a footrest unit of the massage chair according to one embodiment of the invention;

FIG. 4 is a view illustrating a use state of the massage chair according to one embodiment of the invention;

FIG. 5 is a view illustrating an upper body stretching unit according to another embodiment of the invention;

FIG. 6 is a view illustrating the configuration for driving a hand lever by a chain according to one embodiment of the invention;

FIG. 7 is a view illustrating the configuration for driving a hand lever by a cylinder device according to one embodiment of the invention;

FIG. 8 is a view illustrating a massage chair with acupressure bosses and a topical massage device being installed to major portions;

FIG. 9 is a view illustrating a configuration of connecting the upper body stretching unit and the footrest unit according to another embodiment of the invention;

FIG. 10 is a view illustrating an installed state of the lumbar stretching unit and an actuator according to one embodiment of the invention;

FIG. 11 is a perspective view illustrating an actuator of the lumbar stretching unit according to another embodiment of the invention;

FIG. 12 is a perspective view illustrating a lumbar stretching unit according to another embodiment of the invention;

FIG. 13 is a view illustrating an installed state of an air conditioner which is installed to the backrest unit of the massage chair according to one embodiment of the invention; and

FIG. 14 is a view illustrating a backrest cover of the backrest unit.

### MODE FOR INVENTION

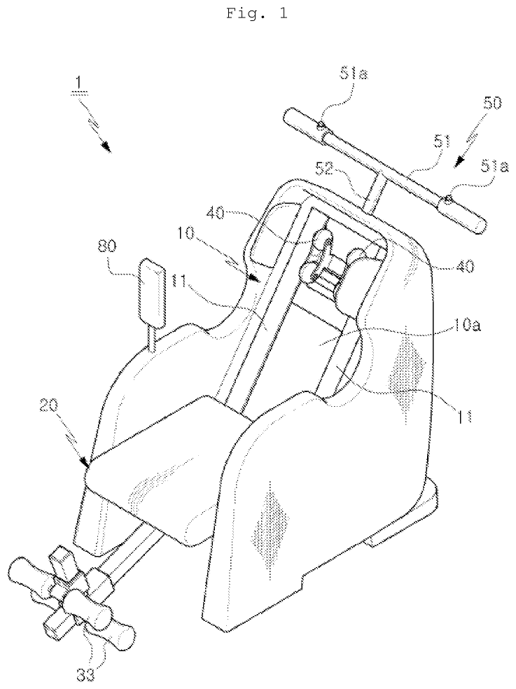

Hereinafter, preferred embodiments of the invention will be described in detail with reference to the accompanying drawings. FIG. 1 is a perspective view illustrating a massage chair with improved massage performance according to one embodiment of the invention, of which a backrest unit is cut. The massage chair includes a backrest unit 10 with a pair of massage rollers 40 installed to left and right sides and being movable in a vertical direction, and a seating unit 20 for supporting a user sitting on the chair. The backrest unit 10 and the seating unit 20 are fixed to and supported by left and right support frames 11 of the massage chair.

As illustrated in FIG. 1, the pair of support frames 11 are disposed in both inner sides of the backrest unit 10, and extend to the seating unit 20 to form an operation space 10a between the support frames 11. The pair of left and right massage rollers 40 are provided in the operation space 10a, and are moved up and down to massage a waist, back and shoulders of a user with vibration.

The massage chair 1 according to the invention is characterized by including an upper body stretching unit 50 provided to the backrest unit 10 to provide the user with a stretching effect.

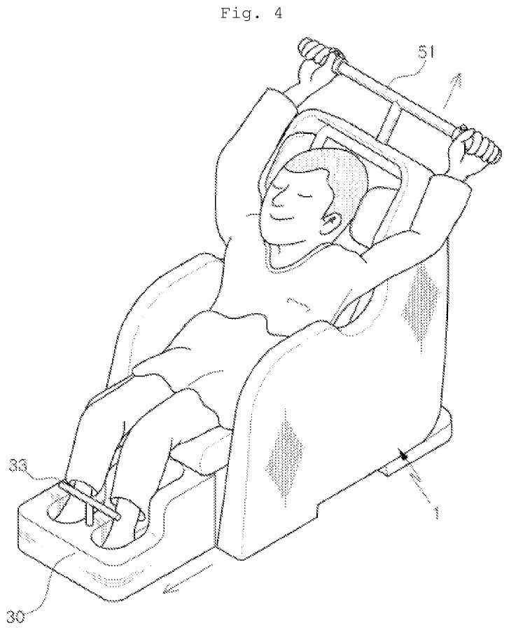

The upper body stretching unit 50 has a hand lever 51 installed to a rear portion of the backrest unit 10 of the massage chair 1 and operated in a vertical direction by a driving force. When a footrest unit 30 installed to a front lower portion of the massage chair is moved forward, the hand lever 51 is also moved up. As illustrated in FIG. 4, when the hand lever 51 is moved up by both hands, the user can relief upper muscles and ligaments through stretching exercise.

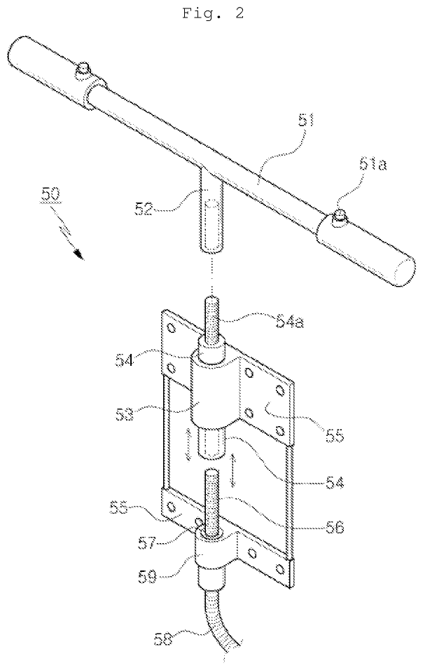

The configuration for lifting the hand lever 51 will now be described. Referring to FIG. 2, an installation plate 55 is fixed to the rear surface of the backrest unit 10, and a lifting plunger 54 is slidably engaged to a shaft support 53 formed on an upper center portion of the installation plate 55. An upper end of the lifting plunger 54 is connected to the hand lever 51.

A screw 56 is disposed below the lifting plunger 54, and is supported by a bearing 57 which is built in a plunger housing at a lower center portion of the installation plate 55. The screw 56 is threadedly engaged to the inner center of the lifting plunger 54. Therefore, the lifting plunger 54 is moved up or down by forward or reverse rotation of the screw 56 to move up and down the hand lever 51.

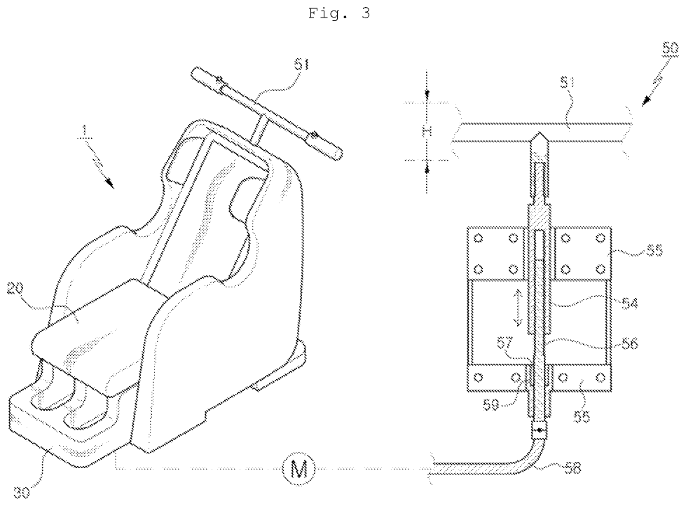

The lower side of the screw 56 for moving the hand lever 51 up and down is connected to a powered cable shaft 58, as illustrated in FIG. 3. The powered cable shaft is connected to a separate driving motor M provided in the massage chair 1. The powered cable shaft 58 is general power transmission means, for example, a flexible wire cable, for transmitting a rotating force of the motor.

The upper portion of the lifting plunger 54 is provided with a threaded rod 54a which is threadedly engaged to the hand lever 51. This is to slightly adjust a lifting height H of the hand lever 51 according to a height of the user.

The lifting height H of the hand lever 51 can be optionally set by the user according to a body condition of the user. As illustrated in the drawings, both sides of the hand lever 51 are provided with a switch 51a, and the hand lever 51 is moved up or down by operation of the switch 51a.

For example, the hand lever may be configured in such a way that when one switch 51a is pressed down, the hand lever is moved up, while when the other switch 51a is pressed down, the hand lever is moved down. Such configuration includes a measuring device, such as a rotary encoder, and may be set and controlled by a remote controller 80.

The massage chair 1 may include an ankle holder 33 for holding both feet of the user at the front lower portion of the massage chair. Since both feet are held by the ankle holder 33 when the upper body stretching unit 50 is moved up, the whole body can receive the stretching effect, as well as the upper body.

The massage chair further includes at the front lower portion thereof the footrest unit 30 having an air tube which is contracted and expanded to massage feet and calves of the user which are put in the air tube. The footrest unit 30 can be moved forward or rearward to stretch the body of the user.

When the footrest 30 is moved forward in the state in which the user is sitting on the massage chair, the hand lever 51 is also moved up to a certain height. When the footrest unit 30 is moved forward, the user performs the stretching exercise in the state in which the air tube for massaging the calves and feet is expanded to strongly hold the legs and feet.

In the case of using the driving motor M, such as a double shaft motor, as illustrated in FIG. 3, the lifting operation of the upper body stretching unit 50 and the horizontal movement of the footrest unit 30 can be carried out only by one motor, and one example of the operation will be described in detail hereinafter.

The massage chair according to the embodiment of the invention includes the upper body stretching unit 50 at the rear side of the chair which is moved in a vertical direction to stretch the whole body. The conventional massage chair provides only functions of vibrating and pressurizing the back and waist by the massage rollers 40, and massaging calves and feet by pneumatic pressure from the footrest unit 30, except for the stretching effect of relaxing the human body.

In the case where the footrest unit 30 and the upper body stretching unit 50 are configured to simultaneously operate in cooperation with each other, as illustrated in FIG. 4 showing the using state, the hand lever 51 is lifted to stretch the upper body while the user holds the hand lever 51 with both hands. At the same time, the footrest unit 30 is moved forward to pull the lower body of the user. Therefore, the upper body and the lower body are simultaneously stretched in upward and downward directions to release the tension in the muscles which is of help to fatigue recovery, and increase flexibility of joints.

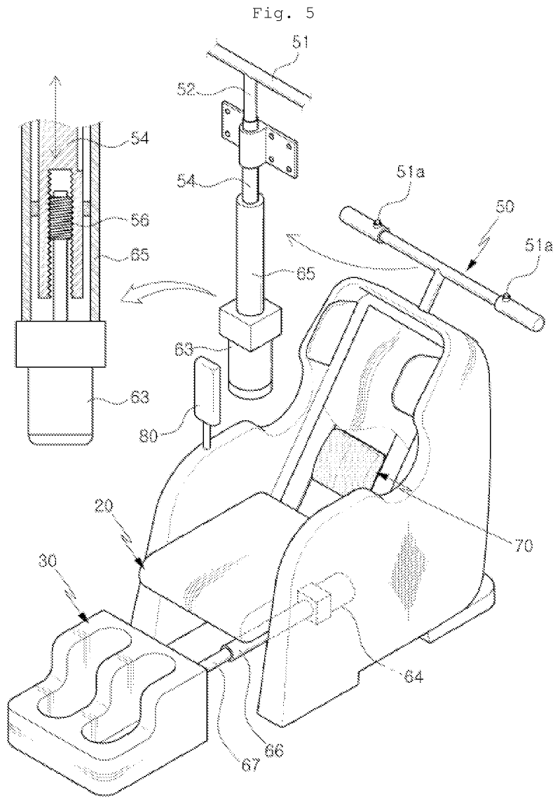

FIGS. 5 to 7 show various methods for operating the upper body stretching unit 50 and the footrest unit 30 in the massage chair according to embodiments of the invention.

As illustrated in FIG. 5, the upper body stretching unit 50 includes a lever lifting motor 63, a stationary tube 65 fixed to an upper portion of the lever lifting motor 63, a lifting plunger 54 moved up and down by rotation of a screw 56 which is engaged to a driving shaft of the lever lifting motor 63, and a vertical supporter 52 engaged to an upper portion of the lifting plunger 54 at the center of the hand lever 51. Accordingly, the hand lever 51 is moved up or down by forward or reverse rotation of the lever lifting motor 63.

Similarly, the footrest unit 30 is connected to a footrest transfer motor 64 so that the footrest unit is moved in the forward and rearward direction to provide the stretching effect. The footrest unit 30 includes the footrest transfer motor 64, a stationary tube 66 fixed to an upper portion of the footrest transfer motor 64, and a footrest transfer plunger 67 engaged to a screw 56 which is engaged to a driving shaft of the footstep transfer motor 64 within the stationary tube 66 and moved up or down by rotation of the screw 56. The footrest transfer plunger 67 is connected to the rear portion of the footrest unit 30 to independently control operation of the upper body stretching unit 50 and the footrest unit 30.

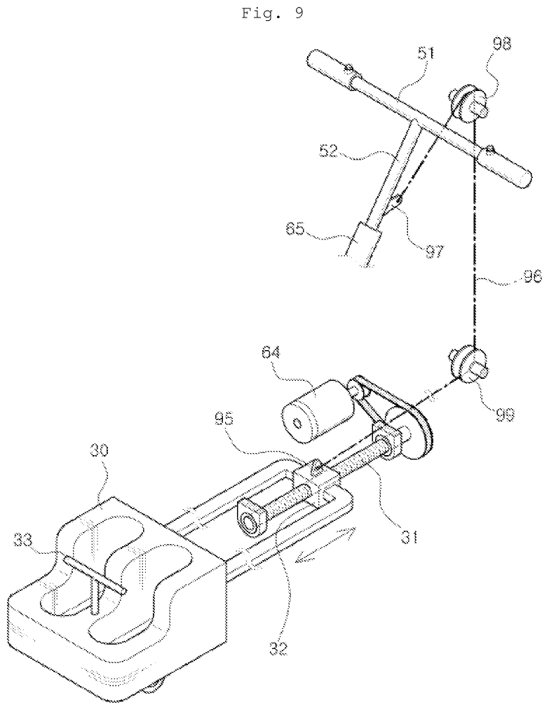

Alternatively, as illustrated in FIG. 9, the footrest unit 30 may include a transfer nut 32 fixed to the footrest unit 30, and a threaded shaft 31 engaged to the transfer nut 32 and rotated by the footrest transfer motor 64 to move the footrest unit 30 in the forward and rearward directions.

In this instance, the footrest unit 30 includes the ankle holder 33 for holding both feet of the user above the footrest to easily stretch the body when the footrest unit 30 moves forward. In the case where the ankle holder 33 is installed, the whole body can receive the stretching effect, even though the upper body stretching unit 50 is operated.

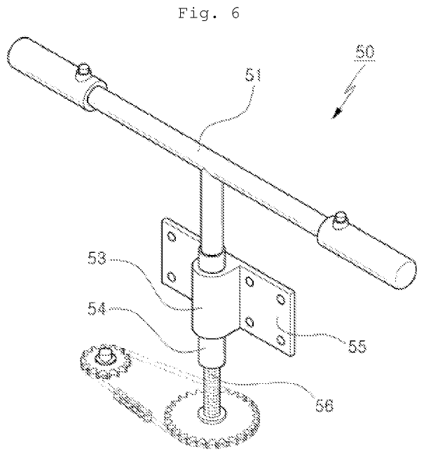

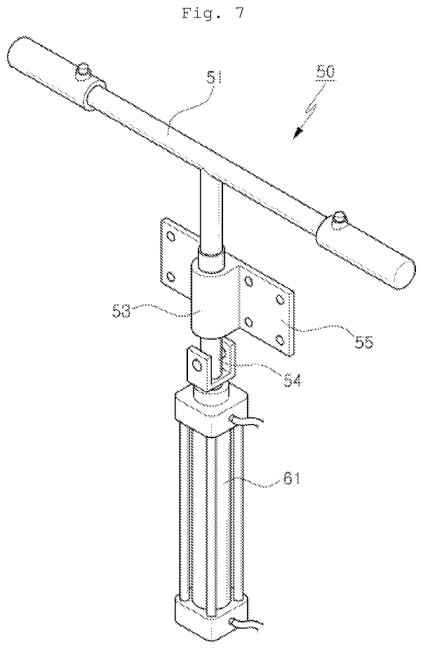

In addition to the vertical movement of the hand lever 51 by the transfer motor 63, as illustrated in FIG. 6, the lower end of the screw 56 is connected to the driving motor by a chain or belt, and when the screw 56 is rotated, the lifting plunger 54 is guided and moved up and down along the shaft support 53 formed on the installation plate 55. Alternatively, as illustrated in FIG. 7, the lifting plunger 54 which is supported by the shaft support 53 formed on the installation plate 55 fixed to the rear surface of the backrest unit 10 may be connected to a rod of a lever cylinder 61 linearly reciprocating.

FIG. 9 is a view illustrating a configuration of connecting the upper body stretching unit and the footrest unit in the massage chair according to another embodiment of the invention. When the footrest unit 30 is moved in the forward and rearward directions by the driving force of the footrest transfer motor 64 provided in the massage chair 1, the hand lever 51 is lifted in cooperation with the movement.

To this end, the footrest unit 30 includes a footrest wire connector 95 formed on the rear surface of the footrest unit and disposed not to interfere in the driving device for moving the footrest in the forward and rearward directions. The hand lever 51 has a handle wire connector 97 at the center of the hand lever.

The footrest unit 30 further includes a lower pulley 99 for guiding a coupling direction of a wire 96 connected to the footrest wire connector 95 toward the upward, and an upper pulley 98 disposed at a higher position than the handle wire connector 97 to connect the wire 96 passing the lower pulley 99 with a handle wire connector 97 formed on the vertical supporter 52, so that the wire 96 is connected from the upper side to the lower side. With the above configuration, the operating direction of the wire is changed by two pulleys, and when the footrest 30 moves forward, the hand lever 51 is moved up to allow the user to stretch the upper and lower bodies at the same time.

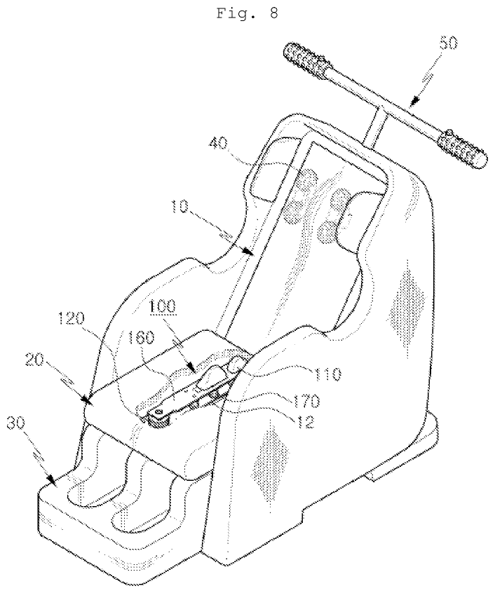

FIG. 8 is a view illustrating a massage chair with acupressure bosses and a topical massage device being installed to major portions. The surfaces of the handles of the hand levers 51 or the surfaces of the massage rollers 40 provided in the backrest unit 10 are provided with a plurality of acupressure bosses to provide a stimulating massage effect.

A topical massage device 100 may be installed to a center portion of the seating unit of the massage chair, as illustrated in FIG. 8. When the topical massage device 100 is installed to the center portion of the seating unit 20, the seating unit 20 supports hips of the user sitting on the chair, and only a massage pad 110 protruding from the seating unit comes into direct contact with the topical region.

Specifically, the topical massage device 100 includes a base plate 12, a plurality of support members 170 engaged to an upper portion of the base plate 12 which is installed to the seating plate, and made of an elastic material having a certain height, and a vibration plate 160 fixed to an upper portion of the respective support members 170.

A massage pad 110 is installed to an upper portion of the vibration plate 160 so as to move in forward and rearward directions, and is made of an elastic resin. A vibrator 120 is engaged to the vibration plate 160 to vibrate the massage pad 110.

The topical massage device 100 is installed to the seating plate of the massage chair 1, and if the power is supplied to the vibrator 120, the vibration plate 160 coupled to the shaft of the vibrator and the massage pad 110 engaged to the upper portion of the vibration plate are softly vibrated at high speed to provide the effective vibration massage to the perineal region and the anal region, thereby preventing the disease of the prostate, improving circulation of blood, and relieving the stress.

The lower portion of the backrest unit 10 of the massage chair includes a lumbar stretching unit 70 having a lumbar supporter 72 connected to an actuator 79 using a cylinder or an electric motor and moved up and down by the actuator, and a cushion 73 attached to the lumbar supporter 72.

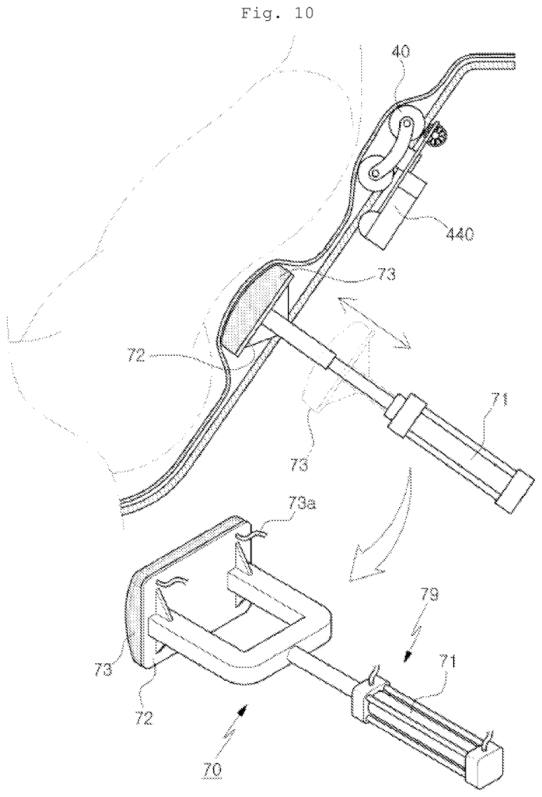

Referring to FIG. 10, the lumbar stretching unit 70 has a lumbar supporting cylinder 71 provided in the massage chair, the lumbar supporter 72 engaged to an end portion of a rod of the cylinder 71, and the cushion 73 attached to the lumbar supporter for giving soft cushion to the user. When the lumbar supporter 72 is moved forward by the lumbar supporting cylinder 71, the lumbar vertebrae of the user is pressurized, so that the user feels relaxation of the waist, and backache is relieved.

If the cushion 73 has an air tube which is expanded or contracted by pneumatic pressure, the cushion 72 is connected to an air hose 73a for supplying the air, so that the size of the air tube is properly varied by the pneumatic pressure to give the optimum stretching effect to the user.

The lumbar stretching unit 70 can further improve the stretching effect of the whole body when it is used in cooperation with the upper body stretching unit 50 and the footrest unit providing the lower body stretching function.

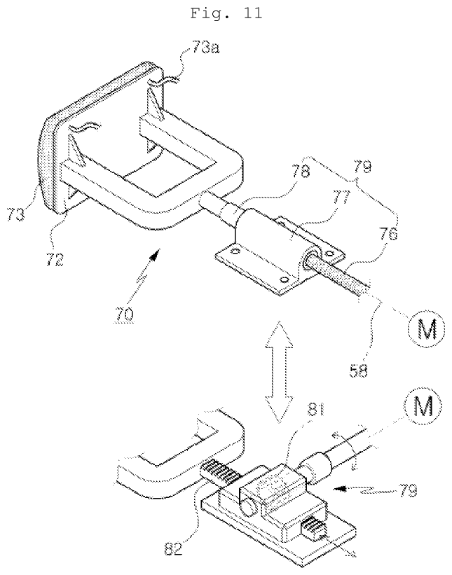

FIG. 11 is a perspective view illustrating the actuator 79 of the lumbar stretching unit 70 according to another embodiment of the invention. When the screw 76 connected to the driving motor M provided in the massage chair is rotated, a lifting plunger 78 threadedly engaged to the screw 76 is guided and lifted by a shaft support 77, and thus the lumbar supporter 72 engaged to the upper end of the lifting plunger 78 is moved up.

Also, the actuator 79 has a rack 81 connected to the driving motor M provided in the massage chair to receive the rotating force, and a pinion 82 connected to a rear end of the lumbar supporter 72 and meshed with the rack 81.

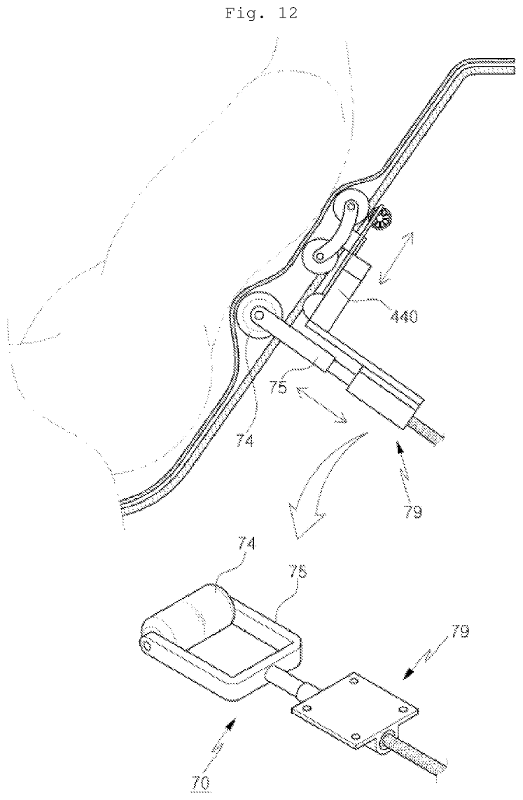

FIG. 12 is a perspective view illustrating the lumbar stretching unit according to another embodiment of the invention. The lumbar stretching unit has a rotary roller 74 and a coupler 75 with one end portion engaged to a rotational shaft of the roller 74 and the other end portion engaged to the actuator 79.

One side of the actuator 79 is fixed to a roller carrier 440, and the roller carrier 440 reciprocates in a vertical direction near the lumbar vertebrae of the user in a stretching mode of the massage chair. When the roller 74 is pushed by operation of the actuator 79, the roller 74 reciprocates in the vertical direction near the waist region while being self-spinning, so that the waist of the user is spread by the rotary roller 74, thereby further improving the stretching effect.

The invention is characterized by further including an air conditioner 460 for supplying air to the operation space 10a in which the massage rollers 40 are operated between the support frames 11, thereby feeding the air of temperature which is wanted by the user.

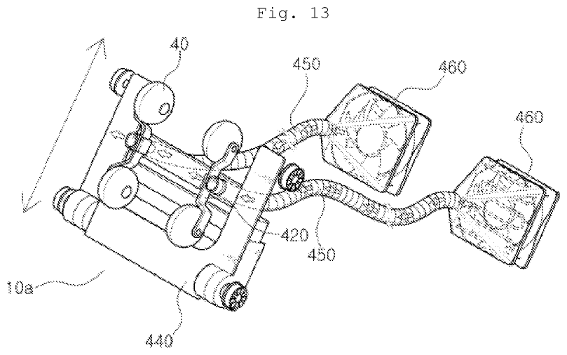

Referring to FIG. 13, the massage rollers 40 are connected to the roller carrier 440 by a massage roller fixture 420 within the backrest unit 10, and the roller carrier 440 reciprocates in the vertical direction along the support frames 11 of the massage chair.

When the massage rollers 40 are operated to pressurize the back and waist of the user, the body is lifted by the massage rollers, so that a wide space is formed around the massage rollers which come into contact with the body. Preferably, the air is fed to the space to supply sufficient air and thus obtain the excellent air discharging effect.

To this end, the massage roller fixture 420 or the roller carrier 440 is connected to an air supply hose 450 made of flexible material to correspond to vertical movement of the massage rollers 40. A rear end of the air supply hose 450 is provided with the air conditioner 460 for supplying hot or cold air, thereby supplying the hot or cold air to the position for massaging the back of the user.

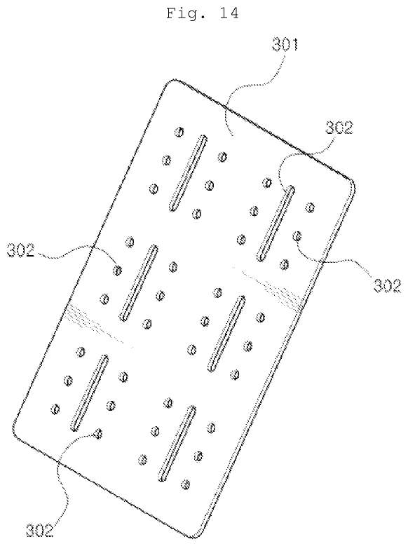

As illustrated in FIG. 14, a cover 301 of the backrest unit 10 of the massage chair is provided with a plurality of air holes 302 to easily supply the air to the user.

The air conditioner 460 is provided with a heater for heating the air and a cooler for cooling the air. In the case where the massage chair is disposed in a room, the air conditioner may be provided with a fan to suck fresh indoor air through an inlet port and supply it to the air supply hose.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

### INDUSTRIAL APPLICABILITY

The configuration of the invention provides the massage chair including the function of stretching the upper and lower bodies of the user which are provided from the existing massage chair, and the new function of stretching the lumbar vertebrae, so that the user can effectively relief upper muscles and ligaments, and get over feeling tired.

1. A massage chair with improved stretching performance comprising:
a seating unit (20);
a backrest unit (10) with a pair of massage rollers (40) installed to left and right sides thereof;
a footrest unit (30) or an ankle holder (33) provided to a front lower portion of the backrest unit (10) to hold both feet; and
an upper body stretching unit (50) installed to a rear portion of the backrest unit (10) to lift a hand lever (51) by a driving force, in which when the hand lever (51) is lifted in a state in which a user holds the hand lever (51) by both hands, the whole body is stretched.

2. The massage chair with the improved stretching performance according to claim 1, wherein the upper body stretching unit (50) includes a lifting plunger (54) which is slidably engaged to a shaft support (53) formed on a rear surface of the backrest unit (10), of which an upper end of the lifting plunger (54) is connected to the hand lever (51); and
a screw (56) which is disposed below the lifting plunger (54), and is supported by a plunger housing (59), with the screw (56) being threadedly engaged to the lifting plunger (54),
in which a lower portion of the screw (56) is connected to a driving motor (M) provided in the massage chair (1), so that the lifting plunger (54) is moved up or down by a rotational direction of the screw (56), and the hand lever (51) is moved up or down.

3. The massage chair with the improved stretching performance according to claim 1, wherein the upper body stretching unit (50) includes a lever lifting motor (63), a stationary tube (65) fixed to an upper portion of the lever lifting motor (63), a lifting plunger (54) moved up and down by rotation of a screw (56) which is engaged to a driving shaft of the lever lifting motor (63), and a vertical supporter (52) engaged to an upper portion of the lifting plunger (54), so that the hand lever (51) is moved up or down by rotation of the lever lifting motor (63).

4. The massage chair with the improved stretching performance according to claim 1, wherein the upper body stretching unit (50) includes a lever cylinder (61) operated by hydraulic pressure or pneumatic pressure, a lifting plunger (54) which is connected to a rod of the lever cylinder (61), and is supported by a shaft support (53) formed on a rear surface of the backrest unit (10) to be slidably moved in a vertical direction, and a vertical supporter (52) engaged to an upper portion of the lifting plunger (54).

5. The massage chair with the improved stretching performance according to claim 1, wherein the footrest unit (30) is provided with an air tube which is contracted or expanded by pneumatic pressure to massage the user, and
the massage chair (1) is provided therein with a footrest transfer motor (64) to move the footrest unit (30) forward or rearward, so that when the hand lever (51) is lifted, the footrest unit (30) is moved forward to pull a lower body of the user, thereby simultaneously stretching upper and lower bodies.

6. The massage chair with the improved stretching performance according to claim 5, wherein the footrest unit 30 includes a stationary tube (66) fixed to a front portion of the footrest transfer motor (64), and a footrest transfer plunger (67) engaged to a driving shaft of the footstep transfer motor (64) and linearly moved within the stationary tube (66), so that the footrest unit (30) is moved forward or rearward.

7. The massage chair with the improved stretching performance according to claim 5, wherein the footrest unit (30) includes a transfer nut (32) fixed to the footrest unit (30), and a threaded shaft (31) engaged to the transfer nut (32) and rotated by the footrest transfer motor (64), so that the footrest unit (30) is moved forward or rearward by rotation of the threaded shaft (31).

8. A massage chair with improved stretching performance comprising:
a seating unit (20);
a backrest unit (10) with a pair of massage rollers (40) installed to left and right sides thereof; and
a footrest unit (30) for massaging a foot and calf of a user,
wherein the footrest unit (30) is moved forward or rearward by a driving force of a footrest transfer motor (64) which is provided in the massage chair (1), thereby stretching a lower body of the user,
a hand lever (51) is installed to an upper portion of the backrest unit (10) so as to be moved in a vertical direction, so that the user sitting on the massage chair can raise both arms to hold the hand lever with both hands, and
a wire (96) is connected between a rear surface of the footrest unit (30) and the hand lever (51) via an upper pulley (98) and a lower pulley (99), so that when the footrest unit (30) moves forwardly, the hand lever (51) is pulled and lifted by the wire (96) connected to the footrest unit (30).

9. The massage chair with the improved stretching performance according to claim 1 or 8, wherein the backrest unit (10) includes at a lower portion thereof a lumbar stretching unit (70) having an actuator (79) and a lumbar supporter (72) connected to the actuator (79) and moved up and down by the actuator, so that when the lumbar supporter (72) moves forward, lumbar vertebrae of the user are pressurized.

10. The massage chair with the improved stretching performance according to claim 9, wherein the actuator (79) has a lumbar supporting cylinder (71) provided in the massage chair and operated by hydraulic pressure or pneumatic pressure, and the lumbar supporter (72) is engaged to an end portion of a rod of the cylinder (71).

11. The massage chair with the improved stretching performance according to claim 9, wherein the actuator (79) has a screw (76) connected to and rotated by a driving motor (M) which is provided in the massage chair, and a lifting plunger (78) threadedly engaged to the screw (76) and guided and lifted by a shaft support (77) when the screw (76) is rotated, in which a lumbar supporter (72) is engaged to an upper end of the lifting plunger (78).

12. The massage chair with the improved stretching performance according to claim 9, wherein the actuator (79) has a rack (81) connected to the driving motor (M) provided in the massage chair and be rotated, and a pinion (82) meshed with the rack (81) and be moved up or down, in which a lumbar supporter (72) is engaged to an upper end of the pinion (82).

13. The massage chair with the improved stretching performance according to claim 1 or 9, further comprising at a lower portion of the backrest unit (10) a lumbar stretching unit (70) including a rotary roller (74), a coupler (75) with one end portion engaged to a rotational shaft of the roller (74), and an actuator (79) connected to the coupler (75) to move the roller (74) forward or rearward,
wherein a roller carrier (440) having the massage rollers (40) is provided in the backrest unit (10), and is moved along a support frame (11) of the massage chair, and
one side of the actuator (79) is fixed to the roller carrier (440), so that the actuator is lifted together with the roller carrier (440).

14. A massage chair with improved stretching performance comprising:
a seating unit (20);
a backrest unit (10) with a pair of massage rollers (40) installed to left and right sides thereof;
support frames (11) provided to support the massage chair (1) from both inner sides of the backrest unit (10) and the seating unit (20); and
an air conditioner (460) provided in the backrest unit (10) to supply air to an operation space (10a) which is formed between the support frames (11), in which the massage rollers (40) are operated.

15. The massage chair with the improved stretching performance according to claim 14, wherein a roller carrier (440) is moved along the support frames (11) of the massage chair within the backrest unit (10),
the massage rollers (40) are installed to a massage roller fixture (420) which is provided on the roller carrier (440),
an air supply hose (450) made of flexible material is engaged to the massage roller fixture (420) or the roller carrier (440), and is moved in corporation with vertical movement of the massage rollers (40), and
the air conditioner (460) is connected to a rear end of the air supply hose (450).

16. The massage chair with the improved stretching performance according to claim 14, wherein the air conditioner (460) is provided with a heater or a cooler, and the backrest unit (10) is provided with a fan to suck indoor air and supply it to the air supply hose.

17. The massage chair with the improved stretching performance according to claim 1, wherein the seating unit (20) is provided at a center portion thereof with a topical massage device including a base plate (12), a plurality of support members (170) engaged to an upper portion of the base plate (12), and made of an elastic material, a vibration plate (160) fixed to an upper portion of the respective support members (170), a massage pad (110) installed and connected to an upper portion of the vibration plate (160), and a vibrator (120) engaged to the vibration plate (160) to vibrate the massage pad (110).

18. The massage chair with the improved stretching performance according to claim 8, wherein the backrest unit (10) includes at a lower portion thereof a lumbar stretching unit (70) having an actuator (79) and a lumbar supporter (72) connected to the actuator (79) and moved up and down by the actuator, so that when the lumbar supporter (72) moves forward, lumbar vertebrae of the user are pressurized.

19. The massage chair with the improved stretching performance according to claim 9, further comprising at a lower portion of the backrest unit (10) a lumbar stretching unit (70) including a rotary roller (74), a coupler (75) with one end portion engaged to a rotational shaft of the roller (74), and an actuator (79) connected to the coupler (75) to move the roller (74) forward or rearward,
wherein a roller carrier (440) having the massage rollers (40) is provided in the backrest unit (10), and is moved along a support frame (11) of the massage chair, and
one side of the actuator (79) is fixed to the roller carrier (440), so that the actuator is lifted together with the roller carrier (440).
